(19) United States
(12) Patent Application Publication
(10) Pub. No.: US 2012/0243602 A1
(43) Pub. Date: Sep. 27, 2012

(54) METHOD AND APPARATUS FOR PIPELINED SLICING FOR WIRELESS DISPLAY

(75) Inventors: Krishnan Rajamani, San Diego, CA (US); Vincent Knowles Jones, Redwood City, CA (US)

(73) Assignee: QUALCOMM Incorporated, San Diego, CA (US)

(21) Appl. No.: 13/239,823

(22) Filed: Sep. 22, 2011

Related U.S. Application Data
(60) Provisional application No. 61/385,860, filed on Sep. 23, 2010.

(51) Int. Cl. H04N 7/26

(52) U.S. Cl. 375/240.02; 375/240.24; 375/E07.076; 375/E07.18

(57) ABSTRACT

Certain aspects of the present disclosure propose methods for processing display data in a pipelined manner. According to certain aspects, a slice size may be selected in a manner that allows for efficient pipelining, which may help achieve acceptable medium access control (MAC) efficiency and reduced latency.

### CLAIM OF PRIORITY UNDER 35 U.S.C. §119

The present Application for Patent claims priority to Provisional Application No. 61/385,860, entitled “PIPELINED SLICING TECHNIQUES FOR WIRELESS DISPLAY,” filed Sep. 23, 2010, and assigned to the assignee hereof and hereby expressly incorporated by reference herein.

### BACKGROUND

1. Field

Certain aspects of the present disclosure generally relate to wireless communications and, more particularly, to processing display data for wireless transmission.

2. Background

Certain wireless display systems provide display mirroring where display data is wirelessly transmitted, allowing elimination of physical cables. In a typical wireless display system, display frames at a source device are captured, compressed (due to bandwidth constraints), and transmitted over a wireless link, such as a Wireless Fidelity (Wi-Fi) connection to a sink device. The sink device decodes the video frames and renders them on its display panel.

Such wireless display systems incur incremental delays due to various processing steps at both ends (e.g., both source and sink devices). The processing steps may include capture, encode and transmit at the source device and decode, de jitter and render at the sink device. As an example, if the average throughput of each of the processing steps is matched with the required bit rate and frame rate for compressed video, the incremental delay may approximately be equal to five frame durations (relative to a locally cabled display). At 30 frames per second (fps), the delay may approximately be equal to 167 milliseconds. Such a large delay may not be desirable for some interactive applications, such as gaming.

### SUMMARY

Certain aspects of the present disclosure provide a method wireless communications. The method generally includes selecting a slice dimension for dividing a video frame into slices, configuring a processing pipeline, based on the selected slice dimension, and encoding a first slice of the video frame in the processing pipeline while transmitting a second, previously encoded, slice of the video frame from a second stage of the processing pipeline.

Certain aspects provide an apparatus for processing display data for wireless transmission. The apparatus generally includes means for selecting a slice dimension for dividing a video frame into slices, means for configuring a processing pipeline, based on the selected slice dimension, and means for encoding a first slice of the video frame in the processing pipeline while transmitting a second, previously encoded, slice of the video frame from a second stage of the processing pipeline.

Certain aspects provide a computer-program product for wireless communications. The computer-program product typically includes a computer-readable medium having instructions stored thereon, the instructions being executable by one or more processors. The instructions generally include instructions for selecting a slice dimension for dividing a video frame into slices, instructions for configuring a processing pipeline, based on the selected slice dimension, and instructions for encoding a first slice of the video frame in the processing pipeline while transmitting a second, previously encoded, slice of the video frame from a second stage of the processing pipeline.

Certain aspects of the present disclosure provide an apparatus for wireless communications. The apparatus generally includes at least one processor and a memory coupled to the at least one processor. The at least one processor is generally configured select a slice dimension for dividing a video frame into slices, configure a processing pipeline, based on the selected slice dimension, and encode a first slice of the video frame in the processing pipeline while transmitting a second, previously encoded, slice of the video frame from a second stage of the processing pipeline.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless display system, in accordance with certain aspects of the present disclosure.

FIG. 2 illustrates a block diagram of a communication system, in accordance with certain aspects of the present disclosure.

FIG. 3 illustrates an example wireless display system, in accordance with certain aspects of the present disclosure.

FIG. 4 illustrates example operations for pipelined processing of display data, in accordance with certain aspects of the present disclosure.

FIG. 4A illustrates example components capable of performing the operations illustrated in FIG. 4.

FIG. 5 illustrates an example source device, in accordance with certain aspects of the present disclosure.

FIG. 6 illustrates an example display system comprising a pipelined source device and a sink device.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

### Example Wireless Display System

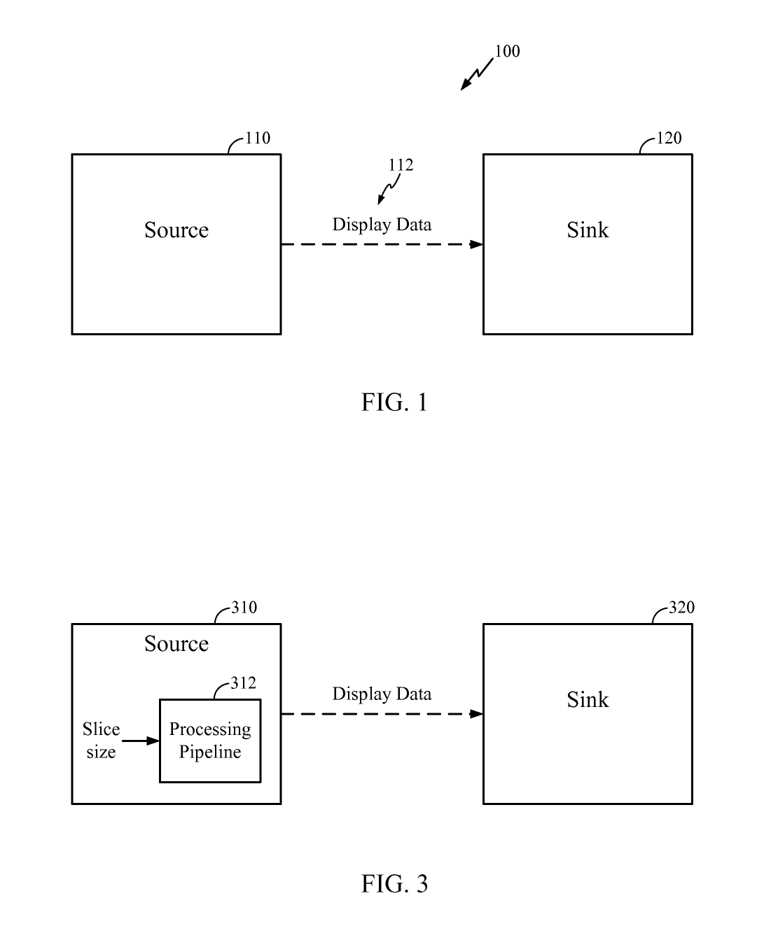

FIG. 1 illustrates an example wireless display system 100, in which various aspects of the present disclosure may be practiced. As illustrated, the display system may include a source device 110 that wirelessly transmits display data 112 to a sink device 120 for display.

The source device 110 may be any device capable of generating and transmitting display data 112 to the sink device 120 for display. Examples of source devices include, but are not limited to, smart phones, cameras, laptop computers, tablet computers, and the like. The sink device may be any device capable of receiving display data from a source device, and displaying the display data on an integrated or otherwise attached display panel. Examples of sink devices include, but are not limited to, televisions, monitors, smart phones, cameras, laptop computers, tablet computers, and the like.

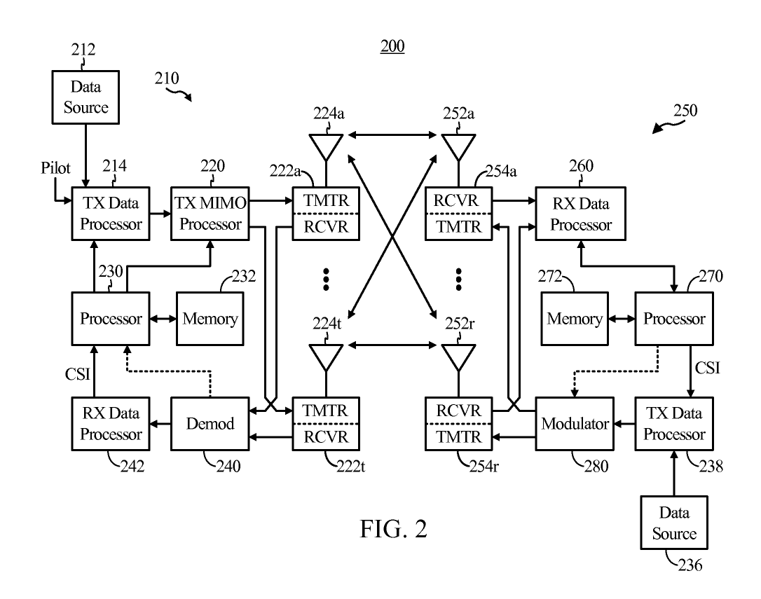

FIG. 2 is a block diagram of an aspect of a transmitter system 210 (which may correspond to a source device) and a receiver system 250 (which may correspond to a sink device) in a multiple input multiple output (MIMO) system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency division multiplexing (OFDM) techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK, or M-QAM (Quadrature Amplitude Modulation), where M may be a power of two) selected for that data stream to provide modulation symbols. The data rate, coding, and modulation for each data stream may be determined by instructions performed by processor 230 which may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A receive (RX) data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210.

A processor 270, that may be coupled with a memory 272, periodically determines which pre-coding matrix to use. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Certain aspects of the present disclosure provide methods for reducing end to end latency of wireless display while maintaining efficiency and throughput of the medium access control (MAC) layer. The techniques proposed herein may be applied to wireless display systems, such as that shown in FIG. 1.

In general, various techniques may be utilized in an attempt to reduce latency. For example, video compression standards such as the H.264 or AVC (advance video coding) standard may allow video encoding to be performed in units of slices rather than full frames. Each of the slices may be encapsulated as a separate network abstraction layer unit (NALU) for transmission. These NALUs may be transmitted as they become available from the processing pipeline. The receiver may decode these slices as they are received.

The slicing technique in the H.264 standard may reduce the end to end delay, in the best case, to 5 slice durations. For example, if each slice is as small as a macro block width (e.g., the smallest possible width) the incremental delay may be approximately 3.7 milliseconds (ms) for 720p resolution (in which the number 720 stands for the 720 horizontal scan lines of display resolution and p stands for progressive scan) at 30 frames per second (fps) or approximately 2.5 ms for 1080p resolution at 30 fps.

However, these theoretical values may not be practical for transmissions that are compatible with some wireless standards such as Wi-Fi (e.g., The Institute of Electrical and Electronic Engineers (IEEE) 802.11). As an example, in a system that utilizes MAC layer acknowledgement (ACK), utilizing a very small slice as an individual wireless transmission unit (e.g., pipeline unit) may significantly degrade the Wi-Fi MAC efficiency and increase the channel time utilization on a shared channel.

For example, at 10 mega bits per second (Mb/s) encode rate, the smallest slice width at 720p30 may result in an encoded payload size of only 926 bytes, which may take approximately 103 microseconds to transmit at a physical layer (PHY) rate of 72 Mb/s. However, the frame exchange overhead including enhanced distributed channel access (EDCA) channel access delay, PHY preamble, short inter-frame space (SIFS) at the end of the frame, and the ACK frame and other delays, may add up to a value that is of the same order of magnitude. As an example, a target for an efficient Wi-Fi link utilization may be a transmit opportunity (TXOP) of 0.5 ms or greater (e.g., ˜1 ms may be desirable for applications such as video). Therefore, the pipeline unit (e.g., slice) may need to be considerably larger to have an efficient Wi-Fi link utilization.

A system that utilizes Wi-Fi MAC may attempt to maximize the efficiency of a desired transmit opportunity (TXOP) size by employing aggregation. For example, size of the TXOP may be increased and used efficiently by aggregating MAC service data units (MSDUs) to form an aggregated MSDU (A-MSDU) and/or by aggregating MAC protocol data units (MPDUs) to form an A-MPDU, in conjunction with Block-ACKs. However these opportunistic techniques may not always have the desired effect when the MSDUs are spaced apart due to encoder delays, which may be the case for the slices in wireless display systems such as Wi-Fi display. In addition, the MAC layer may make transmit scheduling decisions without knowledge of encoder slicing.

For certain aspects of the present disclosure, data units (MSDUs and/or MPDUs) may be delivered to the transmitter (TX) MAC from the encoder output with a size that results in MAC efficiency and reduced latency. Therefore, the slice size may be calculated by jointly optimizing MAC efficiency and latency.

According to certain aspects, a source device 310 illustrated in FIG. 3 may have a processing pipeline 312 that is configurable based on a selected slice size, in accordance with certain aspects described herein. The encoded data may be encapsulated, aggregated, and transmitted to a sink device 320, where slices may be decoded, as they are received, and rendered.

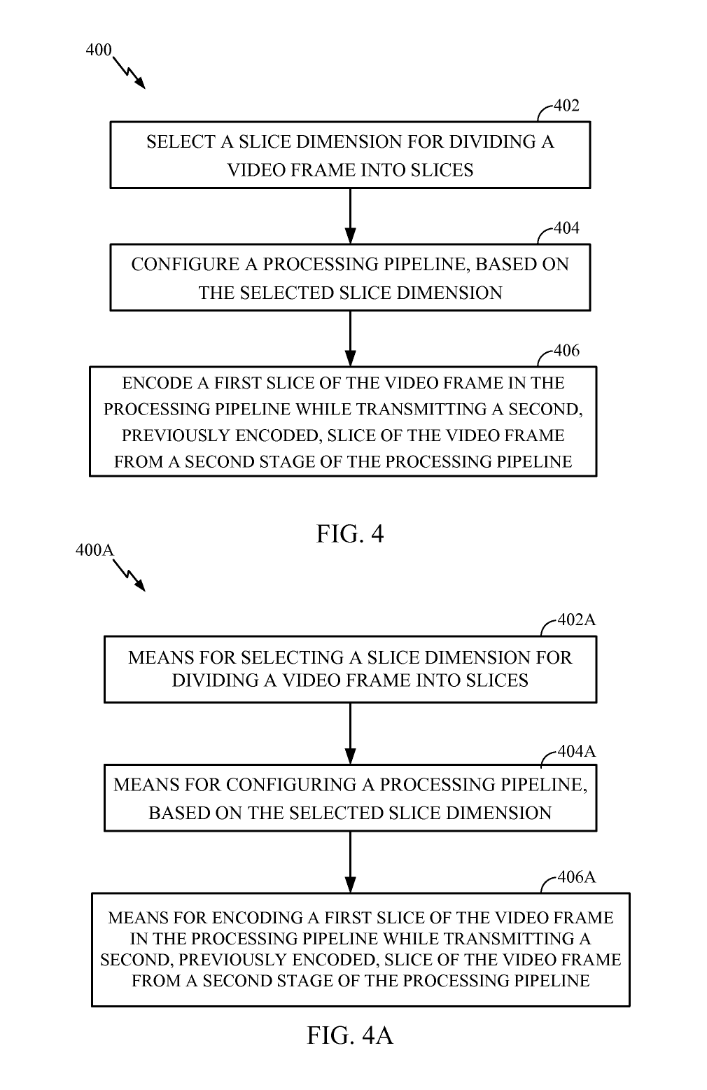

FIG. 4 illustrates example operations 400 that may be performed, for example, at a source device. The operations begin, at 402, by selecting a slice dimension (e.g., size) for dividing a video frame into slices. According to certain aspects, the processing pipeline may be configured on the source device to generate optimally dimensioned slices. According to certain aspects, the slice dimension may be selected as a multiple of a smallest theoretical slice width (e.g., a multiple of the macro block width), with the multiple being large enough to satisfy the Wi-Fi MAC efficiency goal, and small enough to satisfy a latency goal.

At 404, a processing pipeline is configured, based on the selected slice dimension to enable, at 406, encoding a first slice in a first stage of the processing pipeline while transmitting a second, previously pre-processed, slice from a second stage of the processing pipeline. For certain aspects, the slice dimension may be adjusted based on channel conditions between a source device and a sink device.

Another pipeline stage may include display capture and pre-processing steps at the source device (e.g., YUV conversion) which may also be pipelined according to the selected slice dimension. The display capture and pre-processing steps may be pipelined with encoding of the previous slice.

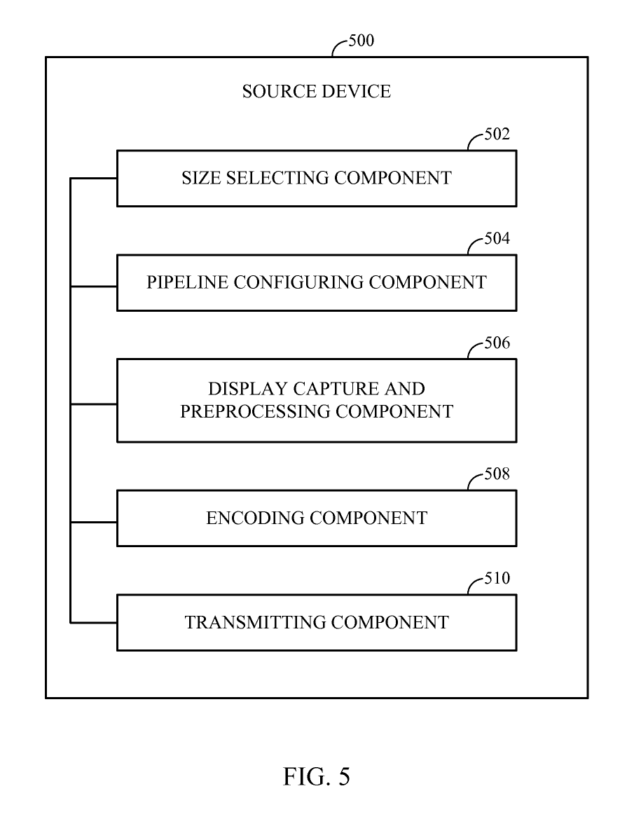

FIG. 5 illustrates an example source device 500, in accordance with certain aspects of the present disclosure. The source device may comprise a size selecting component 502 for selecting slice size of a display frame, a pipeline configuring component 504 for configuring the processing pipeline with the selected slice size, a display capture and pre-processing component 506 for preprocessing a slice, an encoding component 508 for encoding the preprocessed slice and a transmitting component 510 for transmitting the encoded slice to a sink device.

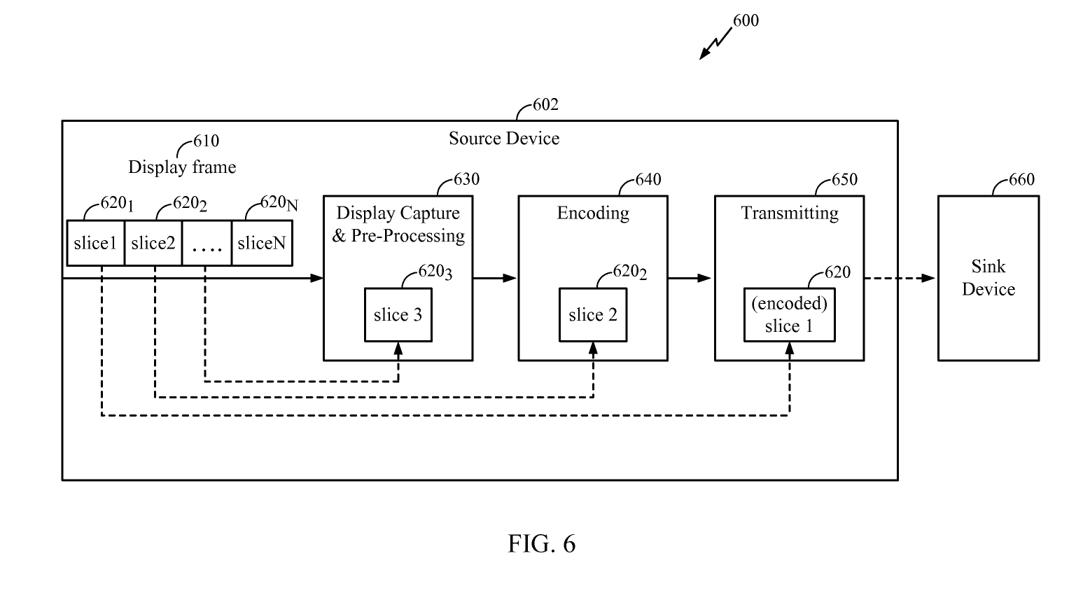

FIG. 6 illustrates an example display system comprising a pipelined source device 602 and a sink device 660. As illustrated, the source device may divide a display frame 610 into slices 620 of a selected size. The source device may pre-process a third slice 620₃ in a first stage 630 of the processing pipeline, while encoding a second slice 620₂ (that has already been pre-processed in the first stage 630), in a second stage 640 of the processing pipeline. The source device may transmit a first slice 620₁ (that has already been preprocessed and encoded) by a transmitting component 650 to a sink device 660.

According to certain aspects, encoded output for each slice may be encapsulated as one or more MAC data units (e.g., MPDUs or MSDUs). The MAC data units may be aggregated prior to transmission to a display sink. The encoded output (for each slice) may be encapsulated and delivered to the source MAC, as one or more MSDUs. This may optionally involve transport layer headers, and/or cryptographic operations to ensure content protection. The source MAC may aggregate these MSDUs before transmission to achieve optimal link utilization (e.g., using A-MSDUs and/or A-MPDUs), in conjunction with Block-ACK. According to certain aspects, a source device may ensure that aggregated data units do not span successive video frames or successive slices.

At the sink device 660, the MAC layer may deliver received MSDUs to a sink application such as a decoder which may operate under a wireless standard such as the IEEE 802.11. According to certain aspects, the sink decoder may decode each slice as it is received. For certain aspects, the sink device may choose to start rendering (e.g., raster scan on its display panel) based on local policy and presentation time considerations. For example, the sink device may start rendering only after all slices for a full video frame have been decoded. The sink device may also start rendering only after a plurality of complete video frames have been decoded and buffered. Or, the sink device may start rendering after a plurality of slices have been decoded and buffered. The policy may depend on the desired Wi-Fi de jitter tolerance. The policy may further be subject to presentation time constraints.

The above actions that are performed by the sink device 660 may be independent of the source device. Each side may independently contribute to the latency improvement, and the savings may be additive. If only one of the source device (or the sink device) optimizes its performance, it may still result in partial performance improvement.

For certain aspects, the slice size may be selected as part of a joint optimization based on one or more of lower bound for a transmit opportunity TXOP, upper bound for end to end latency, or platform processing constraints. For example, the lower bound for TXOP may be equal to 0.5 ms, 1 ms, or the like. This TXOP goal may be selected based on “good channel citizenship” considerations to reduce channel time occupancy for a given payload throughput. The desired payload throughput, which may affect image quality, may also influence the TXOP goal, since very low TXOP values may limit the achievable payload throughput.

The TXOP lower bound may implicitly set a lower bound for the encoder slice size (in Kilo bits) as a function of the nominal PHY rate (e.g., 72 Mb/s, 144 Mb/s, etc.) The PHY rate may in turn depend on the physical layer capabilities of the source and sink devices, channel width (e.g., 20 MHz, 40 MHz, 80 MHz), number of MIMO spatial streams used (e.g., 1, 2 or 4), and current PHY channel conditions. In general, the TXOP goal needs to be higher to ensure higher percentage of channel utilization.

According to certain aspects, slice dimension may be selected based at least on one of a MAC efficiency goal and/or a latency goal. A MAC efficiency goal may be established to ensure the amount of display data sent to the sink device is sufficiently large compared to the messaging overhead. The latency goal may be set to ensure latency does not exceed a tolerable amount. According to certain aspects, a slice dimension may be selected to concurrently achieve at least one latency goal (or throughput measure) and at least one MAC efficiency goal.

For certain aspects, an upper bound for the end to end latency (e.g., latency of the processing steps at both the source and the sink devices) may be considered in selecting the slice size. This goal may depend on the usage model. For example, interactive games may need a lower value for the end to end latency than other applications. The latency upper bound may implicitly set an upper bound for the slice duration. The slice duration may in turn set an upper bound for the encoded slice size (in Kbits) which may be a function of the nominal bit rate of the encoder (e.g., 10 Mb/s, 20 Mb/s). The target bit rate of the encoder may in turn depend on the target utilization percentage of the link capacity and desired quality of the display.

For certain aspects, processing constraints of the platforms (e.g., source or the sink devices) may be considered in selecting the slice size. Typically, the processing demand may increase with a smaller slice, due to the overhead involved locally for each transaction such as inter-process communication, interrupts, and the like. A smaller slice size implies a smaller slice interval, which increases the load on the resources in the platform. This consideration may be used to relax (e.g., increase) the latency upper bound described above.

For certain aspects, implementations may choose to fix the slice dimension at the beginning of a display session (e.g., a Wi-Fi display session) and, optionally, vary the slice dimension adaptively based on link conditions. In general, the algorithm that determines the slice dimensions may operate based on any function of the above parameters or a subset thereof.

An example algorithm that is biased towards barely satisfying the TXOP goal and accepting the resulting latency may be performed by the following steps. First, a TXOP goal T may be selected (e.g., T=0.5 ms) for the MSDU portion. The nominal PHY rate P in Mbits/s may be estimated based at least on the TXOP goal. Next, the available link capacity L may be estimated for the desired payload (e.g., user datagram protocol (UDP), logical link control (LLC) and the like). A target encoder bit rate E may be selected based on a target utilization percentage U of the link capacity L. A target frame rate F in fps may also be chosen. The target size of the encoded slice SS may be calculated based on the nominal PHY rate and the TXOP goal as SS=P×T. The target encoded slice size SS is the amount that may be transmitted during the target TXOP duration (at the estimated PHY rate). The frame size SF may be estimated for a fully encoded frame as follows:

SF=1000*E/F

Next, the optimum slicing dimension may be estimated as follows:

R=SF/SS=(U*L*1000)/(F*P*T).

W=Res/R

D=1/(R*F)

where R may represent ratio of slices per frame, Res may represent resolution, W may represent slice width in terms of scan lines, and D may represent slice duration in milliseconds.

For example, for T=0.5 ms, P=72 Mb/s, L=40 Mb/s, U=40% and F=30 fps, the following values may be calculated: R=14.8 slices/frame and W=49.7 lines. It should be noted that the value of W may need to be rounded to an exact multiple of 16 scan lines (integral number of macro blocks). Therefore, W=48 and R=15. This results in TXOP duration of 0.49 ms for the payload portion of each slice. Slice duration D is approximately 2.2 ms; which results in an end to end delay of approximately 11 ms (˜2.2×5).

A similar algorithm may estimate the slice dimension that barely satisfies the latency bound, and accepts the resulting TXOP. Other alternatives of the proposed method may also be considered, all of which fall in the scope of the present disclosure. For example, if a finite range for slice size satisfies both the TXOP and latency bounds, the optimum value may be chosen based on system preference for latency vs. MAC efficiency. On the other hand, if both constraints can not be jointly satisfied, the source device may relax the less critical constraint (e.g., latency) as a system preference, or compromise both latency and TXOP goals suitably.

The various operations of methods described above may be performed by various hardware and/or software component(s) and/or module(s) corresponding to means-plus-function blocks illustrated in the Figures. For example, blocks 402-406 illustrated in FIG. 4 correspond to means-plus-function blocks 402A-406A illustrated in FIG. 4A. More generally, where there are methods illustrated in Figures having corresponding counterpart means-plus-function Figures, the operation blocks correspond to means-plus-function blocks with similar numbering.

For example, means for selecting a slice dimension 402A may comprise a processor or circuit capable of selecting a size such as the size selecting component 502, means for configuring a processing pipeline 404A may comprise a processor or circuit capable of configuring a processing pipeline such as the pipeline configuring component 504, means for encoding a slice 406A may comprise a processor or circuit capable of encoding a slice such as the encoding component 508 and means for transmitting a slice may comprise a transmitter or the transmitting component 510 illustrated in FIG. 5.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communications, comprising:
selecting a slice dimension for dividing a video frame into slices;
configuring a processing pipeline, based on the selected slice dimension; and
encoding a first slice of the video frame in the processing pipeline while transmitting a second, previously encoded, slice of the video frame from a second stage of the processing pipeline.

2. The method of claim 1, wherein the slice dimension is selected based at least on one of a Medium Access Control (MAC) efficiency goal and a latency goal.

3. The method of claim 2, wherein the slice dimension is selected based on concurrently achieving at least one latency goal or throughput measure and at least one MAC efficiency goal.

4. The method of claim 1, further comprising:
encapsulating encoded output as one or more Medium Access Control (MAC) data units prior to transmission.

5. The method of claim 4, further comprising:
aggregating a plurality of the MAC data units; and
transmitting an aggregated MAC data unit to a display sink.

6. The method of claim 5, wherein aggregating the plurality of the MAC data units comprises:
aggregating only MAC data units with encoded data that do not span successive video frames.

7. The method of claim 5, wherein aggregating the plurality of the MAC data units comprises:
aggregating only MAC data units with encoded data that do not span successive slices of video frames.

8. The method of claim 1, further comprising:
adjusting the slice dimension based on channel conditions between a source device and a sink device.

9. An apparatus for wireless communications, comprising:
means for selecting a slice dimension for dividing a video frame into slices;
means for configuring a processing pipeline, based on the selected slice dimension; and
means for encoding a first slice of the video frame in the processing pipeline while transmitting a second, previously encoded, slice of the video frame from a second stage of the processing pipeline.

10. The apparatus of claim 9, wherein the slice dimension is selected based at least on one of a Medium Access Control (MAC) efficiency goal and a latency goal.

11. The apparatus of claim 10, wherein the slice dimension is selected based on concurrently achieving at least one latency goal or throughput measure and at least one MAC efficiency goal.

12. The apparatus of claim 9, further comprising:
means for encapsulating encoded output as one or more Medium Access Control (MAC) data units prior to transmission.

13. The apparatus of claim 12, further comprising:
means for aggregating a plurality of the MAC data units; and
means for transmitting an aggregated MAC data unit to a display sink.

14. The apparatus of claim 13, wherein the means for aggregating comprises:
means for aggregating only MAC data units with encoded data that do not span successive video frames.

15. The apparatus of claim 13, wherein the means for aggregating comprises:
means for aggregating only MAC data units with encoded data that do not span successive slices of video frames.

16. The apparatus of claim 9, further comprising:
means for adjusting the slice dimension based on channel conditions between a source device and a sink device.

17. A computer-program product for wireless communications, comprising a computer-readable medium having instructions stored thereon, the instructions being executable by one or more processors and the instructions comprising:
instructions for selecting a slice dimension for dividing a video frame into slices;
instructions for configuring a processing pipeline, based on the selected slice dimension; and
instructions for encoding a first slice of the video frame in the processing pipeline while transmitting a second, previously encoded, slice of the video frame from a second stage of the processing pipeline.

18. The computer-program product of claim 17, wherein the slice dimension is selected based at least on one of a Medium Access Control (MAC) efficiency goal and a latency goal.

19. The computer-program product of claim 18, wherein the slice dimension is selected based on concurrently achieving at least one latency goal or throughput measure and at least one MAC efficiency goal.

20. The computer-program product of claim 17, further comprising:
instructions for encapsulating encoded output as one or more Medium Access Control (MAC) data units prior to transmission.

21. The computer-program product of claim 20, further comprising:
instructions for aggregating a plurality of the MAC data units; and
instructions for transmitting an aggregated MAC data unit to a display sink.

22. The computer-program product of claim 21, wherein the instructions for aggregating the plurality of the MAC data units comprise:
instructions for aggregating only MAC data units with encoded data that do not span successive video frames.

23. The computer-program product of claim 21, wherein the instructions for aggregating the plurality of the MAC data units comprise:
instructions for aggregating only MAC data units with encoded data that do not span successive slices of video frames.

24. The computer-program product of claim 17, further comprising:
instructions for adjusting the slice dimension based on channel conditions between a source device and a sink device.

25. An apparatus for wireless communications, comprising at least one processor configured to:
select a slice dimension for dividing a video frame into slices,
configure a processing pipeline, based on the selected slice dimension, and
encode a first slice of the video frame in the processing pipeline while transmitting a second, previously encoded, slice of the video frame from a second stage of the processing pipeline; and
a memory coupled to the at least one processor.

26. The apparatus of claim 25, wherein the slice dimension is selected based at least on one of a Medium Access Control (MAC) efficiency goal and a latency goal.

27. The apparatus of claim 26, wherein the slice dimension is selected based on concurrently achieving at least one latency goal or throughput measure and at least one MAC efficiency goal.

28. The apparatus of claim 25, wherein the at least one processor is further configured to:
encapsulate encoded output as one or more Medium Access Control (MAC) data units prior to transmission.

29. The apparatus of claim 28, wherein the at least one processor is further configured to:
aggregate a plurality of the MAC data units; and
transmit an aggregated MAC data unit to a display sink.

30. The apparatus of claim 29, wherein the at least one processor is further configured to:
aggregate only MAC data units with encoded data that do not span successive video frames.

31. The apparatus of claim 29, wherein the at least one processor is further configured to:
aggregate only MAC data units with encoded data that do not span successive slices of video frames.

32. The apparatus of claim 25, wherein the at least one processor is further configured to:
adjust the slice dimension based on channel conditions between a source device and a sink device.
